(19) United States
(12) Patent Application Publication
(10) Pub. No.: US 2014/0258453 A1
(43) Pub. Date: Sep. 11, 2014

(54) METHOD FOR CONTROLLING CONTENTS TRANSMISSION

(71) Applicant: Samsung Electronics Co., Ltd., Gyeonggi-do (KR)

(72) Inventor: Seung-Yeon CHOE, Gyeonggi-do (KR)

(73) Assignee: Samsung Electronics Co., Ltd., Gyeonggi-do (KR)

(21) Appl. No.: 14/193,141

(22) Filed: Feb. 28, 2014

(30) Foreign Application Priority Data
Mar. 7, 2013 (KR) 10-2013-0024509

(51) Int. Cl. H04L 29/08

(52) U.S. Cl. CPC H04L 67/10
USPC 709/217

(57) ABSTRACT

A method is provided for transmitting content that includes detecting, by an electronic device, a content transmission event; and responsive to the content transmission event, processing a content item to hide location information that is associated with the content item and transmitting the content item to a remote device.

### CLAIM OF PRIORITY

This application claims priority under 35 U.S.C. §119(a) to a Korean Patent Application filed in the Korean Intellectual Property Office on Mar. 7, 2013 and assigned Serial No. 10-2013-0024509, the contents of which are herein incorporated by reference.

### TECHNICAL FIELD

The present disclosure relates to a method and apparatus for content transmission.

### BACKGROUND

Electronic devices, such as portable terminals, often include a camera and provide various services related to the capturing and transmission of images. Sometimes, digital images captured by such devices are geocoded to include an indication of the geographic location where they were captured. However, the geographic locations where images are captured may be considered private information under some circumstances. Thus, when a user shares a geocoded image, the user may inadvertently communicate private information.

To prevent the inadvertent sharing of private information, may remove such indications of geographic locations from the images they share. However, removing indications of geographic locations from geocoded images may be inconvenient to many smartphone users. For example, it may require a user to download the geocoded images to his or her personal computer, open an image editing program, and erase metadata that is part of the images. Moreover, in instances where a user wants to share a whole gallery of images, the above process may need to be performed separately for each image in the gallery.

Accordingly the need exists for preventing the dissemination of geolocation data.

### SUMMARY

The present disclosure addresses this need. According to one aspect of the disclosure, a method for transmitting content is provided, the method comprising: detecting, by an electronic device, a content transmission event; and responsive to the content transmission event, processing a content item to hide location information that is associated with the content item and transmitting the content item to a remote device.

According to another aspect of the disclosure, an electronic device is provided comprising a processor configured to: detect a content transmission event; and responsive to the content transmission event, process a content item to hide location information that is associated with the content item and transmit the content item to a remote device.

### BRIEF DESCRIPTION OF THE DRAWINGS

The above and other objects, features and advantages of the present disclosure will become more apparent from the following detailed description when taken in conjunction with the accompanying drawings in which:

FIG. 1 is a block diagram of an electronic device according to aspects of the disclosure;

FIG. 2 is block diagram illustrating a construction of a processor according to aspects of the present disclosure;

FIG. 3 is a flowchart of a process for transmitting the contents to a remote electronic device according to aspects of the present disclosure;

FIG. 4 is a flowchart of another process for transmitting contents to a remote electronic device according to aspects of the disclosure;

FIG. 5 is a flowchart of yet another process for transmitting contents to a remote electronic device according to aspects of the disclosure; FIG. 6 is a flowchart of yet another process for transmitting contents according to aspects of the disclosure;

FIG. 7A is a diagram illustrating a table for managing contents in an electronic device according to aspects of the disclosure; and

FIG. 7B is a diagram illustrating a table for managing contents metadata according to aspects of the present disclosure.

### DETAILED DESCRIPTION

Preferred examples will be described herein below with reference to the accompanying drawings. In the following description, well-known functions or constructions are not described in detail since they may obscure concepts that are considered more pertinent. Terms used in the disclosure should be interpreted based on the context of the disclosure.

In one aspect, the present disclosure relates to a method and apparatus for hiding location information included in contents and transmitting the contents to a remote electronic device. The electronic device can include a mobile communication terminal, a Personal Digital Assistant (PDA), a laptop computer, a smart phone, a netbook, a television, a Mobile Internet Device (MID), an Ultra Mobile Personal Computer (UMPC), a tablet PC, a navigator, a refrigerator, a digital watch, and an MPEG Audio Layer-3 (MP3) player, and/or any other suitable device. The contents can include at least one of a photo, video, a document, and or any suitable content item that is capable of including metadata. In some instances, the metadata can include at least one of an EXchangeable Image File (EXIF) metadata, an eXtensible Metadata Platform (XMP) metadata, and an International Press Telecommunications Council (IPTC) metadata, and it may include location information.

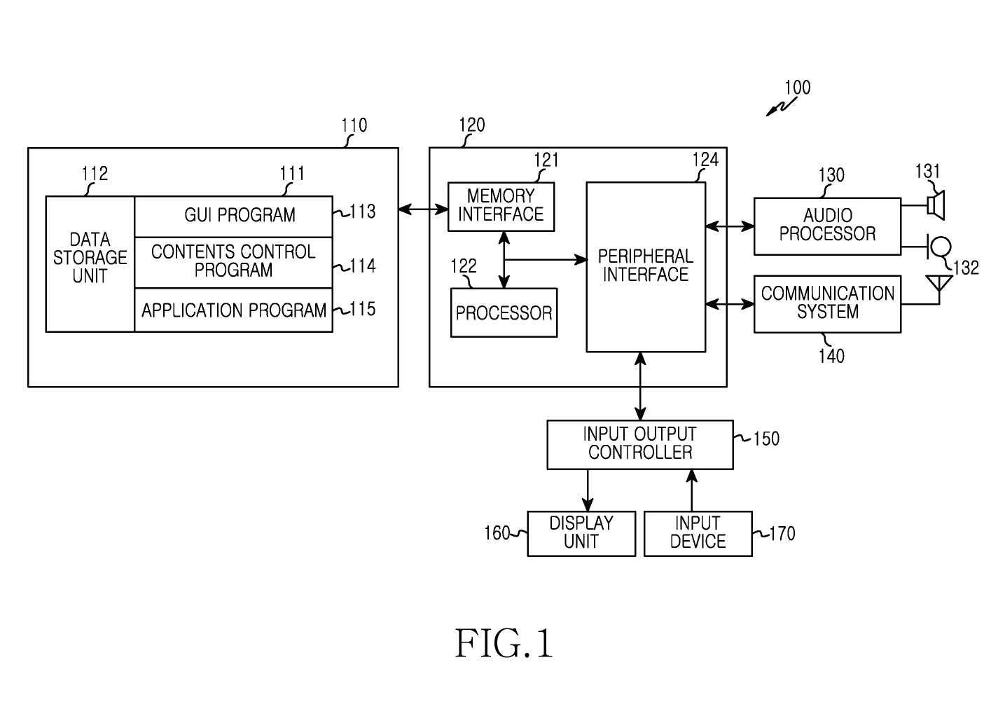

FIG. 1 is a block diagram of an electronic device 100 according to aspects of the disclosure. As illustrated in FIG. 1, the electronic device 100 can include a memory 110, a processor unit 120, an audio processor 130, a communication system 140, an input-output controller 150, a display unit 160, and an input device 170.

The memory 110 can include random access memory (RAM), a read-only memory, (ROM), a flash memory, EEPROM memory, a solid state drive (SSD), a hard drive, and or any suitable type of volatile or non-volatile memory. In some aspects, the memory 110 can include a program storage unit 111 storing a program for controlling an operation of the electronic device 100 and a data storage unit 112 storing data generated during program execution. The program storage unit 111 can include a Graphical User Interface (GUI) program 113, a contents control program 114, and at least one application program 115. The data storage unit 112 can include at least one software constituent element for transmitting contents to a remote electronic device in the electronic device 100. For example, the data storage unit 112 stores at least one of content and metadata associated with the content.

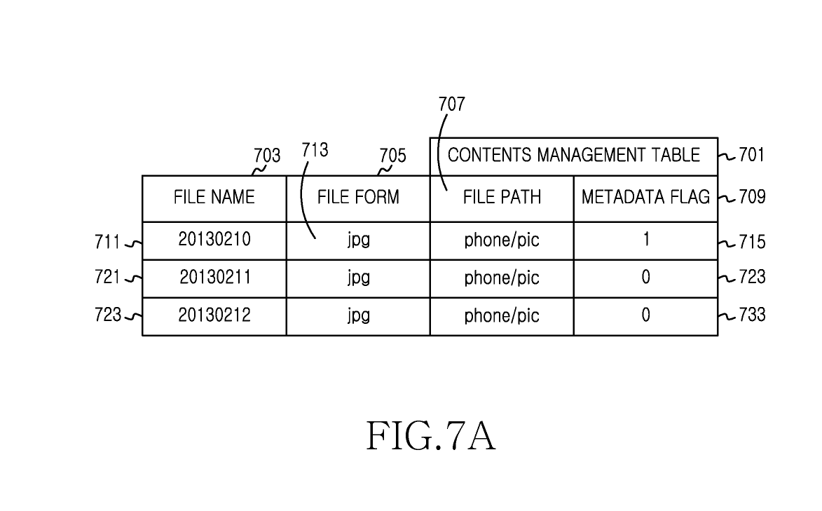

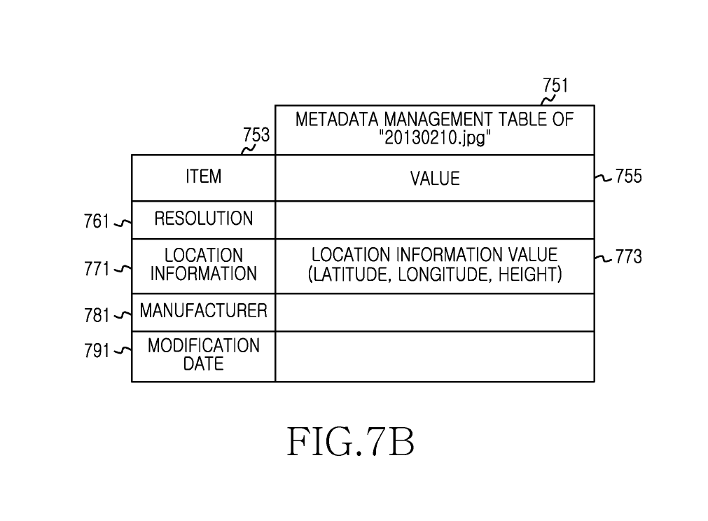

In some implementations, the contents control program 114 can include processor executable instructions for including location information in contents. The contents control program 114 can manage contents metadata by using a record, such as the metadata management table 751 which is depicted in FIG. 7B. As illustrated in FIG. 7B, the metadata management table 751 corresponds to a file named “20130210.jpg” and includes a location information 771 field, for storing location information. For example, the location information 771 may indicate at least one of a latitude, longitude, and height.

Additionally or alternatively, in some implementations, the contents control program 114 can include processor executable instructions for hiding location information that is included in contents. The hiding of the location information may be performed as part of a transmission of the content to a remote device. In that regard, the hiding may include making a copy of the content, deleting any location information that is contained in the metadata management table of the content copy, and transmitting the content copy to the remote device. Alternatively, the hiding of the location information may include making a copy of the content, replacing any location information that is contained in the metadata management table of the content copy with arbitrary value(s), and transmitting the content copy to the remote device.

Additionally or alternatively, in some implementations, the contents control program 114 may include processor-executable instructions for restricting content transmission based on at least one of current location of the electronic device 100 and context of the electronic device 100. For example, when detecting a current location of the electronic device 100 and recognizing that the current location matches a preset location, the contents control program 114 may prevent transmission of the location information included in the contents. As another example, when at least one application program (e.g., an enterprise security program) is being executed by the electronic device 100, at the time when the transmission of a contents item is requested, the contents control program 114 may prevent transmission of the location information included in the contents.

The GUI program 113 includes one or more processor executable instructions for providing a user interface on the display unit 160. For example, the GUI program 113, when executed by the electronic device 100 (or processor thereof), may cause the electronic device 100 to display a screen of at least one application program 115 on the display unit 160. The application program 115 can include any suitable software that is executed by the electronic device 100.

The processor unit 120 can include electronic circuitry for hiding of location metadata. In some implementations, the processor 120 can include an ARM-based processor, an x86-based processor, a special-purpose processor, an FPGA, and/or any suitable type of electronic circuitry. Additionally or alternatively, in some implementations, the processor 130 can include a memory interface 121, at least one processor 122, and a peripheral interface 124. Here, the memory interface 121, the at least one processor 122, and the peripheral interface 124, which are included in the processor unit 120, can be integrated as at least one integrated circuit or realized as separate constituent elements. The memory interface 121 may control access of a constituent element such as the processor 122 or the peripheral interface 124 to the memory 110. The peripheral interface 124 may control the connection of the processor 122 and the memory interface 121 with an input-output peripheral device of the electronic device 100. The processor 122 may control the electronic device 100 to provide various multimedia services using at least one software program. For example, the processor 122 can control to execute at least one program stored in the memory 110 and provide a service according to the corresponding program.

The audio processor 130 may include electronic circuitry for providing an audio interface between a user and the electronic device 100 through a speaker 131 and a microphone 132.

The communication system 140 can include hardware and/or software for performing a communication function for voice communication and data communication. In one example, the communication system 140 may include a plurality of communication sub modules supporting different communication networks. For example, the communication network can include, though not limited to, a Global System for Mobile Communication (GSM) network, an Enhanced Data GSM Environment (EDGE) network, a Code Division Multiple Access (CDMA) network, a Wireless-Code Division Multiple Access (W-CDMA) network, a Long Term Evolution (LTE) network, an Orthogonal Frequency Division Multiple Access (OFDMA) network, a Wireless Local Area Network (WLAN), a Bluetooth network, and a Near Field Communication (NFC) network.

The input-output controller 150 provides an interface between the peripheral interface 124 and an input-output device such as the display unit 160, the input device 170 and the like.

The display unit 160 displays status information of the electronic device 100, a character input by a user, a moving picture, and a still picture. For example, the display unit 160 displays display data provided from the GUI program 113. The display unit 160 may include a touchscreen and/or any suitable type of output device.

The input device 170 may include a physical button or a physical keypad for providing input into the electronic device 100 and/or otherwise controlling the operation of the electronic device 100. Additionally or alternatively, the input device 170 may be part of a touch screen. In such instances, the input device 170 may include a touch screen and a touch input unit for providing touch information, which is sensed through a touch panel, to the processor unit 120 through the input-output controller 150.

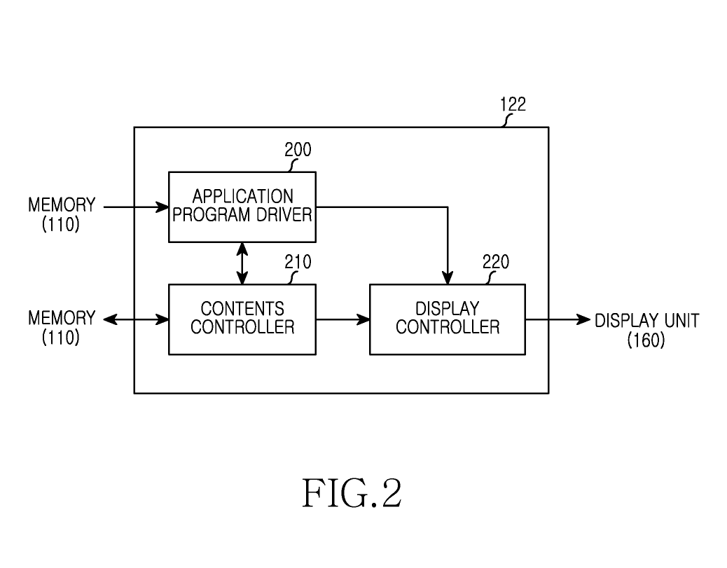

FIG. 2 is a block diagram of the processor 122 according to aspects of the disclosure. As illustrated in FIG. 2, the processor 122 can include an application program driver 200, a contents controller 210, and a display controller 220. The application program driver 200 may execute at least one application program 115 stored in the program storage unit 111.

In some implementations, the contents controller 210 may include electronic circuitry configured to include location information in contents. In some implementations, the contents controller 210 can manage contents metadata by using a record, such as the metadata management table 751 which is depicted in FIG. 7B. As illustrated in FIG. 7B, the metadata management table 751 corresponds to a file named “20130210.jpg” and includes a location information 771 field which may indicate at least one of a latitude, longitude, and height.

Additionally or alternatively, in some implementations, the contents controller 210 can include electronic circuitry configured to hide location information that is included in contents. The hiding of the location information may be performed as part of a transmission of the content to a remote device. In that regard, the hiding may include making a copy of the content, deleting any location information that is contained in the metadata management table of the content copy, and transmitting the content copy to the remote device. Alternatively, the hiding of the location information may include making a copy of the content, replacing any location information that is contained in the metadata management table of the content copy with arbitrary value(s), and transmitting the content copy to the remote device.

Additionally or alternatively, in some implementations, the contents controller 210 may include electronic circuitry for restricting content transmission based on at least one of current location of the electronic device 100 and context of the electronic device 100. For example, when detecting a current location of the electronic device 100 and recognizing that the current location is a preset location, the contents controller 210 may prevent transmission of the location information included in the contents. As another example, when at least one application program (e.g., an enterprise security program) is being executed by the electronic device 100, at the time when the transmission of contents item is requested, the contents controller 210 may prevent transmission of the location information included in the contents.

The display controller 220 may include electronic circuitry configured to output a graphical user interface (GUI) on the display unit 160. In some instances, the GUI may be part of the application 115.

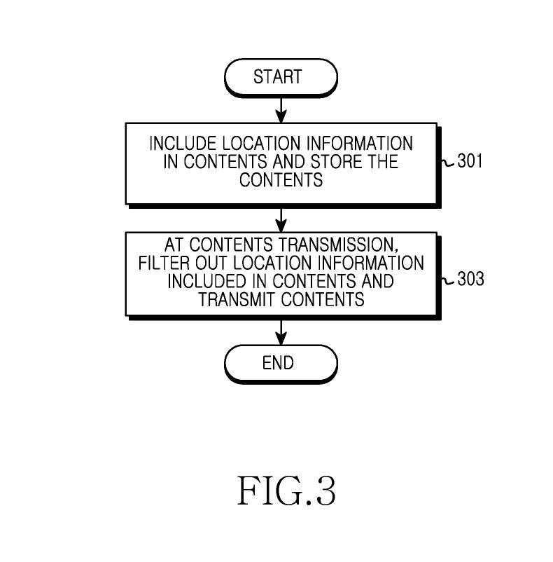

FIG. 3 is a flowchart of a process for transmitting contents according to aspects of the disclosure. In step 301, the electronic device includes location information in one or more content items and stores the content items in the memory of the electronic device. In some instances, the electronic device can store the respective location information of each content item in a metadata record that is part of that content item. For example, the metadata record may be implemented as the metadata management table 751 which is shown in FIG. 7B. As illustrated, the metadata management table 753 can identify various items 751 stored in different fields of the table, such as a resolution 761, location information 771, a manufacturer identifier 781, and a modification date 791. Each item 753 can include a corresponding value 755. For example, the location information 771 can include a location information value 773 including at least one of latitude, longitude, and height. The at least one item included in the metadata table can be specified by the manufacturer of the device 100. It should be noted that the metadata table 751 is provided as an example only, and any suitable type of information may be incorporated into the contents' metadata, in other examples.

In step 303, the electronic device processes each of the content items to hide location information that is associated with that content item. For example, the electronic device may delete all metadata that is part of each processed content item and then transmit the content item to the remote electronic device. As another example, for each processed content item, the electronic device may remove only location information that is part of the metadata of that content item (e.g., the field of 771). As yet another example, for each of the processed content items, the electronic device may set the location information field value of a metadata record for that content item to an arbitrary value in order to conceal the true location information associated with the content item.

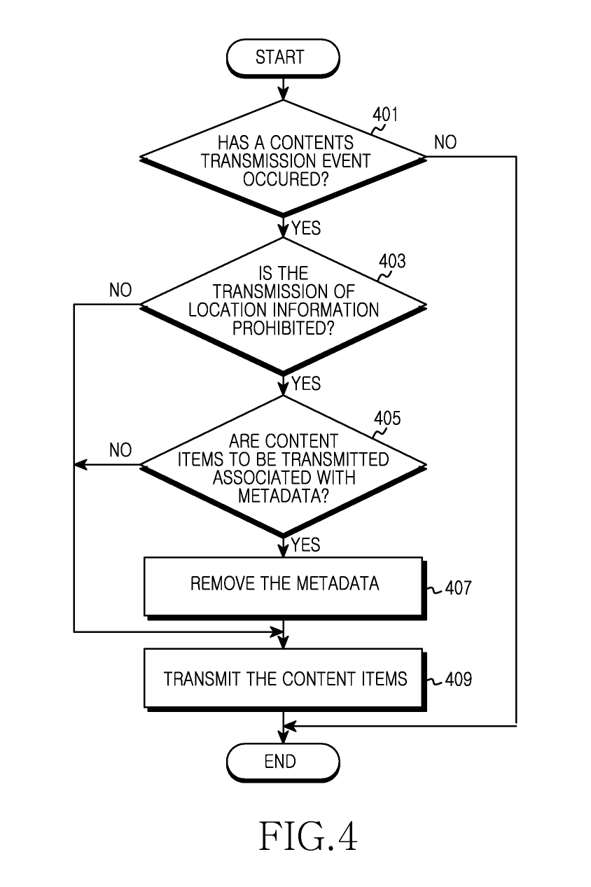

FIG. 4 is a flowchart of another process for transmitting contents according to aspects of the disclosure. In step 401, the electronic device determines if a contents transmission event has occurred. For example, the electronic device may determine if a request for transmitting content to a remote electronic device has been received. If it is determined that the contents transmission event has not occurred, the process ends. Otherwise, if the contents transmission event is detected, the process proceeds to step 403.

In step 403, the electronic device determines if a location information transmission prohibition has been set. In some implementations, the prohibition may be set in response to a user input indicating that the user does not want location information associated with content to be disseminated. In other implementations, whether the transmission of location information is prohibited may depend on the current state of the electronic device. For example, when detecting that the electronic device is located at a predetermined location, the electronic device can prohibit the transmission of the location information included in the contents. As another example, when a preset at least one application program (e.g., an enterprise security program) is executed by the electronic device, at the time when the contents transmission event takes place, the electronic device may prohibit the transmission of the location information included in the contents. If it is determined in step 403 that the location information transmission prohibition has not been set, the process proceeds to step 409. Otherwise, the process proceeds to step 405.

In step 405, the electronic device determines whether one or more content items (hereinafter “contents)” include (or are otherwise associated with) a metadata record. In some instances, the determination may be based on a supplementary record stored in the memory of the electronic device that includes indication(s) whether each of a plurality of content items is associated with a metadata record. In some instances, the supplementary record may be implemented as the table 701 which is depicted in FIG. 7A. As illustrated, the record may include identifiers 703 for content items 711, 721, and 723. In addition, the record may include an identifier 705 of the type 713 of each of the content items. Furthermore, the record may include an indication 707 of a file path associated with each content item and a metadata flag 709 associated with each content item. The values 715, 723, and 733 of the metadata flag 709 indicate whether each of the content items 711, 721, and 723, respectively, includes (or is otherwise associated with) a metadata record. For example, as illustrated in FIG. 7A, if there is a request for transmission of contents whose file names 703 are equal to “20130210” (711), “20130211 (721), and “20130212” (723), the electronic device identifies a value of a “metadata flag” 709 for each content item to determine if metadata for that content item exists. The metadata may be included in the contents or it may be stored separately from the contents. For example, as illustrated in FIG. 7A, if “metadata flag” 701 for a given content item is equal to “0”, the electronic device recognizes that metadata associated with the given content item does not exist. Alternatively, if the metadata flag is set to “1” the electronic device recognizes that metadata associated with the given content item exists. If it is determined that the metadata does not exist for any of the content items, the process proceeds to step 409. Otherwise, if it is determined that metadata for at least one content item exists, the process proceeds to step 407.

In step 407, the electronic device removes from the contents any metadata records that are part of the contents. Afterwards, at step 409, the electronic device transmits the contents to the remote electronic device. The transmission may take place over any suitable type of communications network.

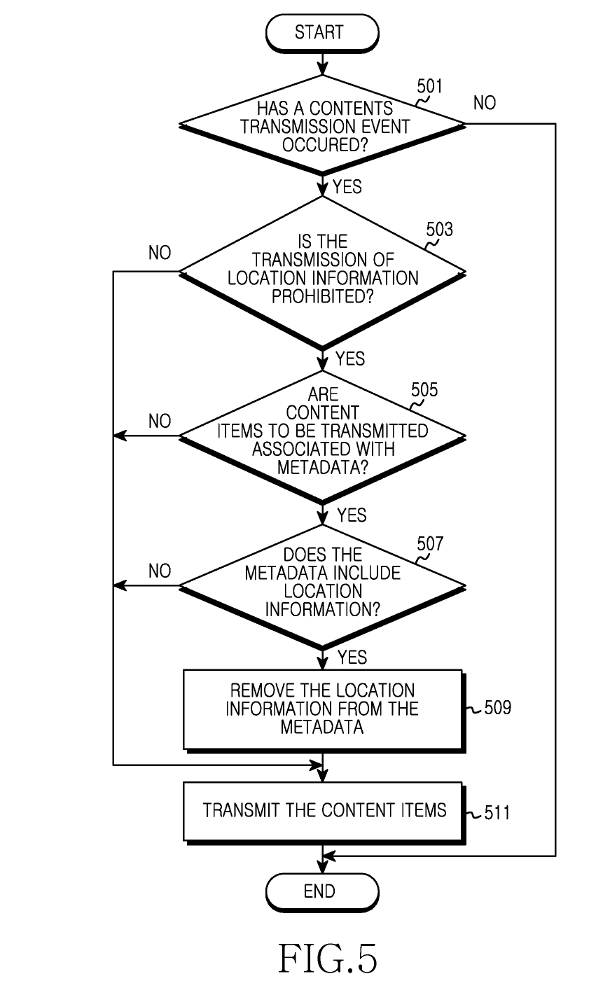

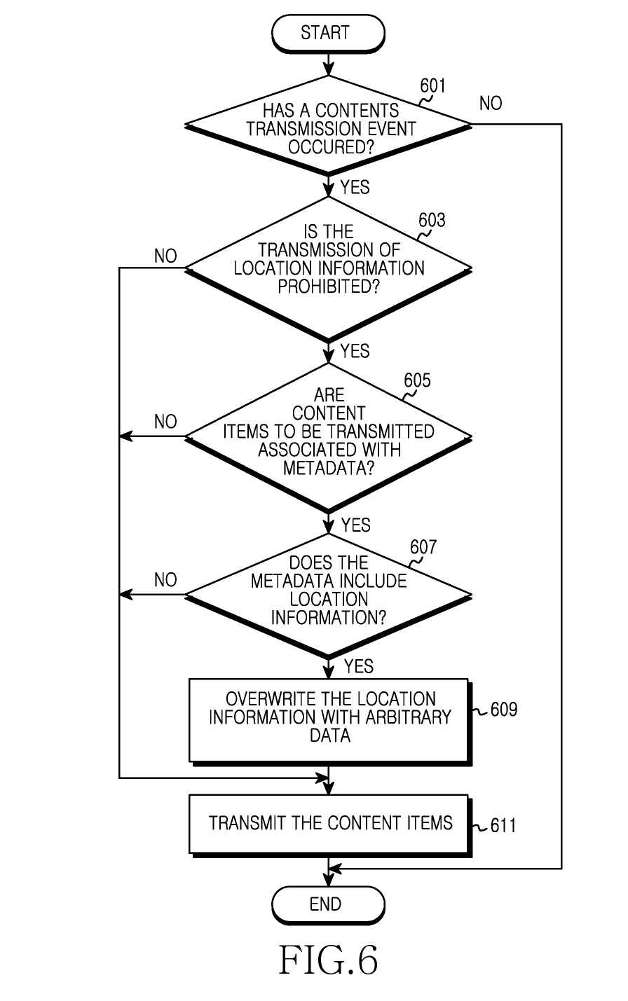

FIG. 5 depicts a flowchart of yet another process for transmitting contents according to aspects of the disclosure. In step 501, the electronic device determines if a contents transmission event has occurred. For example, the electronic device may determine if a request for transmitting content to a remote electronic device has been received. If it is determined that the contents transmission event has not occurred, the process ends. Otherwise, if the contents transmission event is detected, the process proceeds to step 503.

In step 503, the electronic device determines if a location information transmission prohibition has been set. In some implementations, the prohibition may be set in response to a user input indicating that the user does not want location information associated with content to be disseminated. In other implementations, whether the transmission of location information is prohibited may depend on the current state of the electronic device. For example, when detecting that the electronic device is located at a predetermined location, the electronic device can prohibit the transmission of the location information included in the contents. As another example, when a preset at least one application program (e.g., an enterprise security program) is executed by the electronic device, at the time when the contents transmission event takes place, the electronic device may prohibit the transmission of the location information included in the contents. If it is determined in step 503 that the location information transmission prohibition has not been set, the process proceeds to step 511. Otherwise, the process proceeds to step 505.

In step 505, the electronic device determines whether one or more content items (hereinafter “contents)” include (or are otherwise associated with) a metadata record. In some instances, the determination may be based on a supplementary record stored in the memory of the electronic device that includes indication(s) whether each of a plurality of content items is associated with a metadata record. In some instances, the supplementary record may be implemented as the table 701 which is depicted in FIG. 7A. For example, as illustrated in FIG. 7A, if “metadata flag” 701 is equal to “0” for a given content item, the electronic device recognizes that metadata associated with the given content item does not exist. Alternatively, if the metadata flag is set to “1,” the electronic device recognizes that metadata associated with the given content item exists. If it is determined that the metadata does not exist for any of the content items, the process proceeds to step 511. Otherwise, if it is determined that metadata for at least one content item exists, the process proceeds to step 507.

In step 507 the electronic device determines if the metadata associated with each one of the content items includes location information. For example, for each of the content items, the electronic device may determine if a location information field exists in a metadata record that is associated with that content item. If it is determined in that location information is not part of the metadata record of any of the content items, the process proceeds to step 511. Otherwise, if it is determined that the metadata record of at least one content item includes location information, the process proceeds to step 509.

In step 509, the electronic device removes all location information from each content item's metadata record. As noted above, the electronic device may simply delete the location information (e.g., e.g., delete the location information in a copy of 10 the contents that is to be transmitted). At step 511, the electronic device transmits the content items (or copies of the content items) to the remote device. The transmission may take place over any suitable type of communications network.

FIG. 6 depicts a flowchart of yet another process for transmitting contents according to aspects of the disclosure. In step 601, the electronic device determines if a contents transmission event has occurred. For example, the electronic device may determine if a request for transmitting content to a remote electronic device has been received. If it is determined that the contents transmission event has not occurred, the process ends. Otherwise, if the contents transmission event is detected, the process proceeds to step 603.

In step 603, the electronic device determines if a location information transmission prohibition has been set. In some implementations, the prohibition may be set in response to a user input indicating that the user does not want location information associated with content to be disseminated. In other implementations, whether the transmission of location information is prohibited may depend on the current state of the electronic device. For example, when detecting that the electronic device is located at a predetermined location, the electronic device can prohibit the transmission of the location information included in the contents. As another example, when a preset at least one application program (e.g., an enterprise security program) is executed by the electronic device, at the time when the contents transmission event takes place, the electronic device may prohibit the transmission of the location information included in the contents. If it is determined in step 603 that the location information transmission prohibition has not been set, the process proceeds to step 611. Otherwise, the process proceeds to step 605.

In step 605, the electronic device determines whether one or more content items (hereinafter “contents)” include (or are otherwise associated with) a metadata record. In some instances, the determination may be based on a supplementary record stored in the memory of the electronic device that includes indication(s) whether each of a plurality of content items is associated with a metadata record. In some instances, the supplementary record may be implemented as the table 701 which is depicted in FIG. 7A. For example, as illustrated in FIG. 7A, if “metadata flag” 701 is equal to “0” for a given content item, the electronic device recognizes that metadata associated with the given content item does not exist. Alternatively, if the metadata flag is set to “1,” the electronic device recognizes that metadata associated with the given content item exists. If it is determined that the metadata does not exist for any of the content items, the process proceeds to step 611. Otherwise, if it is determined that metadata for at least one content item exists, the process proceeds to step 607.

In step 607 the electronic device determines if the metadata associated with each one of the content items includes location information. For example, for each of the content items, the electronic device may determine if a location information field exists in a metadata record that is associated with that content item. If it is determined in that location information is not part of the metadata record of any of the content items, the process proceeds to step 611. Otherwise, if it is determined that the metadata record of at least one content item includes location information, the process proceeds to step 609.

In step 609, the electronic replaces all location information in the metadata associated with the content items with arbitrary values. For example, for each content item that is associated with metadata, the electronic device may overwrite the location information in that content item's metadata record with randomly generated data. At step 611, the electronic device transmits the content items to the remote device.

It should be note that FIGS. 1-7B are provided as examples only. Some of the steps shown in FIGS. 3-6 can be performed in a different order, concurrently, or altogether omitted. Most of the foregoing alternative embodiments are not mutually exclusive, but may be implemented in various combinations to achieve unique advantages. As these and other variations and combinations of the features discussed above can be utilized without departing from the disclosure as defined by the claims, the foregoing description of the embodiments should be taken by way of illustration rather than by way of limitation of the disclosure as defined by the claims. It will also be understood that the provision of examples of the disclosure (as well as clauses phrased as “in accordance with one aspect,” “such as,” “including” and the like) should not be interpreted as limiting the disclosure to the specific examples; rather, the examples are intended to illustrate only one of many possible embodiments.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the invention has been shown and described with reference to certain preferred embodiments thereof, it will be understood by those skilled in the art that various changes in form and details may be made therein without departing from the spirit and scope of the disclosure as defined by the appended claims

What is claimed is:

1. A method for transmitting content, the method comprising:
detecting, by an electronic device, a content transmission event; and
responsive to the content transmission event, processing a content item to hide location information that is associated with the content item and transmitting the content item to a remote device.

2. The method of claim 1, wherein processing the content item to hide the location information comprises hiding the location information based on a current location of the electronic device.

3. The method of claim 1, wherein processing the content item to hide the location information comprises hiding the location information based on whether a predetermined software application is being executed by the electronic device.

4. The method of claim 1, wherein hiding the location information comprises deleting the location information from a metadata record that is part of the content item.

5. The method of claim 1, wherein hiding the location information comprises overwriting the location information with arbitrary information.

6. The method of claim 1, further comprising:
storing in a memory of the electronic device a record that indicates whether each of a plurality of content items comprises metadata;
wherein the content item is processed to hide the location information only when the record indicates that the content item comprises metadata.

7. The method of claim 1, wherein hiding the location information includes removing from the content item a metadata record that is part of the content item.

8. The method of claim 7, wherein the metadata record comprises at least one of an EXchangeable Image File (EXIF), an eXtensible Metadata Platform (XMP), and an International Press Telecommunications Council (IPTC) record.

9. The method of claim 1, further comprising:
receiving, by the electronic device, an input indicating a user preference for hiding location information that is part of content upon transmission of the content to a remote device;
wherein processing the content item to hide the location information comprises hiding the location information based on the user preference.

10. The method of claim 1, wherein processing the content item to hide location information includes determining whether a metadata record that is part of the content item includes location information.

11. An electronic device comprising a processor configured to:
detect a content transmission event; and
responsive to the content transmission event, process a content item to hide location information that is associated with the content item and transmit the content item to a remote device.

12. The electronic device of claim 11, wherein processing the content item to hide the location information comprises hiding the location information based on a current location of the electronic device.

13. The electronic device of claim 11, wherein processing the content item to hide the location information comprises hiding the location information based on whether a predetermined software application is being executed by the electronic device.

14. The electronic device of claim 11, wherein hiding the location information comprises deleting the location information from a metadata record that is part of the content item.

15. The electronic device of claim 11, wherein hiding the location information comprises overwriting the location information with arbitrary information.

16. The electronic device of claim 11, wherein:
the processor is further configured to store in a memory of the electronic device a record that indicates whether each of a plurality of content items comprises metadata; and
the content item is processed to hide the location information only when the record indicates that the content item comprises metadata.

17. The electronic device of claim 11, wherein hiding the location information includes removing from the content item a metadata record that is part of the content item.

18. The electronic device of claim 17, wherein the metadata record comprises at least one of an EXchangeable Image File (EXIF), an eXtensible Metadata Platform (XMP), and an International Press Telecommunications Council (IPTC) record.

19. The electronic device of claim 11, wherein:
the processor is further configured to receive an input indicating a user preference for hiding location information that is part of content upon transmission of the content to a remote device;
wherein processing the content item to hide the location information comprises hiding the location information based on the user preference.

20. The electronic device of claim 11, wherein processing the content item to hide location information includes determining whether a metadata record that is part of the content item includes location information.
